(19) United States
(12) Patent Application Publication
(10) Pub. No.: US 2008/0127567 A1
(43) Pub. Date: Jun. 5, 2008

(54) Latch for Sliding Door

(76) Inventor: Ali Nikkhah, Mission Viejo, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/736,389

(22) Filed: Apr. 17, 2007

Related U.S. Application Data
(60) Provisional application No. 60/868,392, filed on Dec. 4, 2006.

(51) Int. Cl. B65D 45/00; E05D 15/06

(52) U.S. Cl. 49/404; 292/256

(57) ABSTRACT

A latch assembly for a sliding door includes a latch base having a generally channel-shaped configuration for receiving the stile of a sliding door and a handle pivotally coupled to the latch base having a lift portion facing outward from the door. When the lift portion is pulled, the door stile is released from the latch base and the door is pushed away from the doorjamb by a tab portion of the handle, both actions occurring substantially simultaneously.

### 1. CROSS-REFERENCE TO RELATED APPLICATION

This application claims priority of provisional application 60/868,392, filed Dec. 4, 2006.

### BACKGROUND OF THE INVENTION

1. Field of the Invention

The present invention relates generally to a latch assembly for sliding doors and, more particularly, to an easily releasable latch for positively securing a sliding door in a closed position as required, for example, in recreational vehicles.

2. Background

Sliding doors are widely used in a variety of applications, such as cabinets, closets and wardrobes. In many instances, it is desirable to secure a sliding door in a closed position. This is particularly true for installations in recreational vehicles, where an unsecured door can pose a safety hazard. While it is important to secure a door in the closed position, it is also desirable to make it convenient to open the door when desired. Thus, a sliding door latch should be easy to operate, preferably with only one hand.

### SUMMARY OF THE INVENTION

The present invention provides a two-part latch assembly for a sliding door. A latch base has a generally channel-shaped configuration for receiving the stile of a sliding door. A handle is pivotally coupled to the latch base having a lift portion facing outward from the door. When the lift portion is pulled, the door stile is released from the latch base and the door is pushed away from the doorjamb by a tab portion of the handle, both actions occurring substantially simultaneously.

### BRIEF DESCRIPTION OF THE DRAWINGS

FIG. 1 illustrates an environment in which the present invention may be utilized.

FIG. 2 is a detailed view showing a latch assembly in accordance with the present invention in association with a sliding door.

FIG. 3 is a perspective view of a latch base used in the latch assembly shown in FIG. 2.

FIG. 4 is a perspective view of a latch handle used in the latch assembly shown in FIG. 2.

FIG. 5 illustrates the latch assembly in a “closed” position.

FIG. 6 illustrates the latch assembly in an “open” position.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

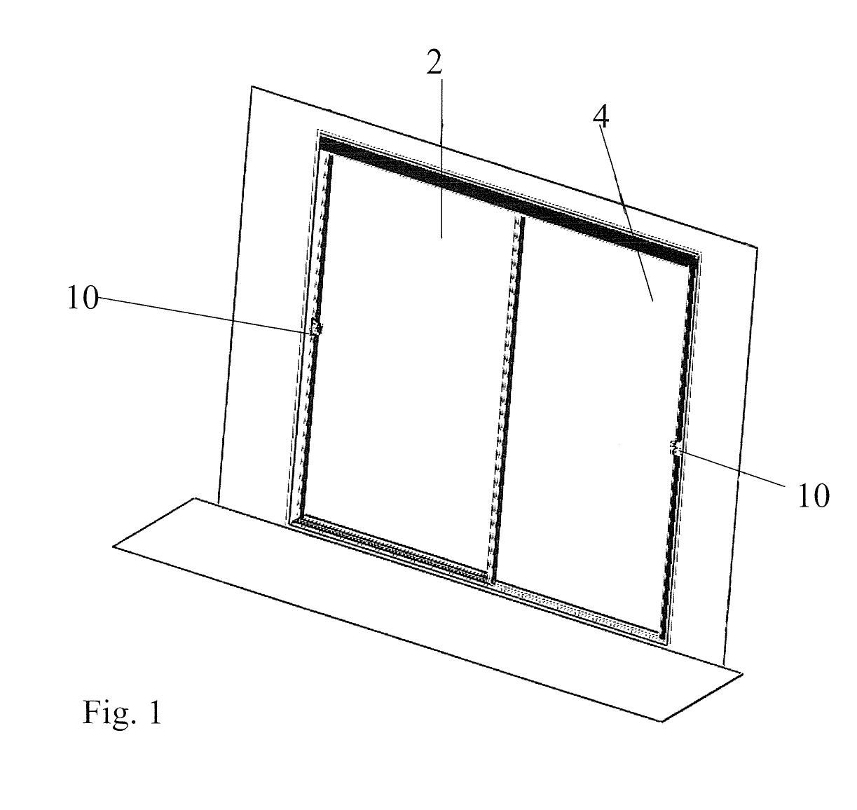

FIG. 1 shows a pair of sliding doors 2, 4 such as might be used for a closet or wardrobe. For many applications, the door panels may be mirrors; however, the invention is not limited in this regard and may be used with any type of sliding panel. A latch assembly 10 is installed on each side of the doorframe to secure each of the doors in a closed position.

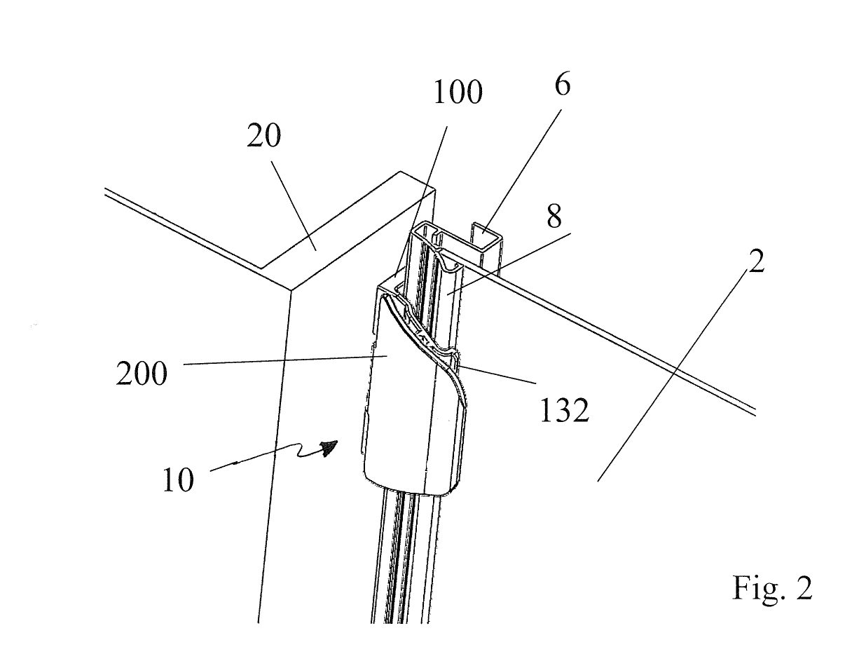

FIG. 2 is a partial cross-sectional view showing latch assembly 10 securing door 2 in a closed position. Latch assembly 10 comprises a latch base 100, which is secured to doorjamb 20 with screws or other suitable fastening hardware. The latch base includes a catch portion 132 that fits over and retains the protruding lip portion 8 of door stile 6. Latch assembly 10 further comprises handle 200 with which the latch is released as will be described more fully below.

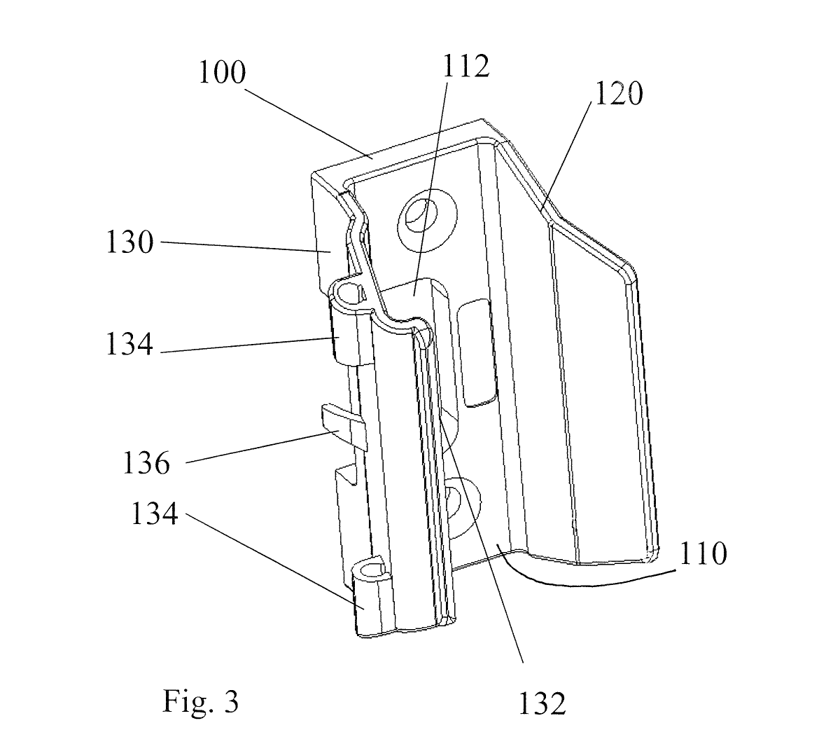

FIG. 3 is a perspective view of the latch base 100. This component may be made of nylon or other suitable resilient material with shape “memory”, including metals and other plastics. The latch base has a generally channel-shaped configuration with a channel bottom portion 110 and channel wall portions 120, 130. Wall portion 130 includes the catch portion 132. Wall portion 130 also includes pivot bearings 134 and spring member 136, the functions of which will be described below. Channel bottom portion 110 includes an aperture 112, the function of which will also be described below.

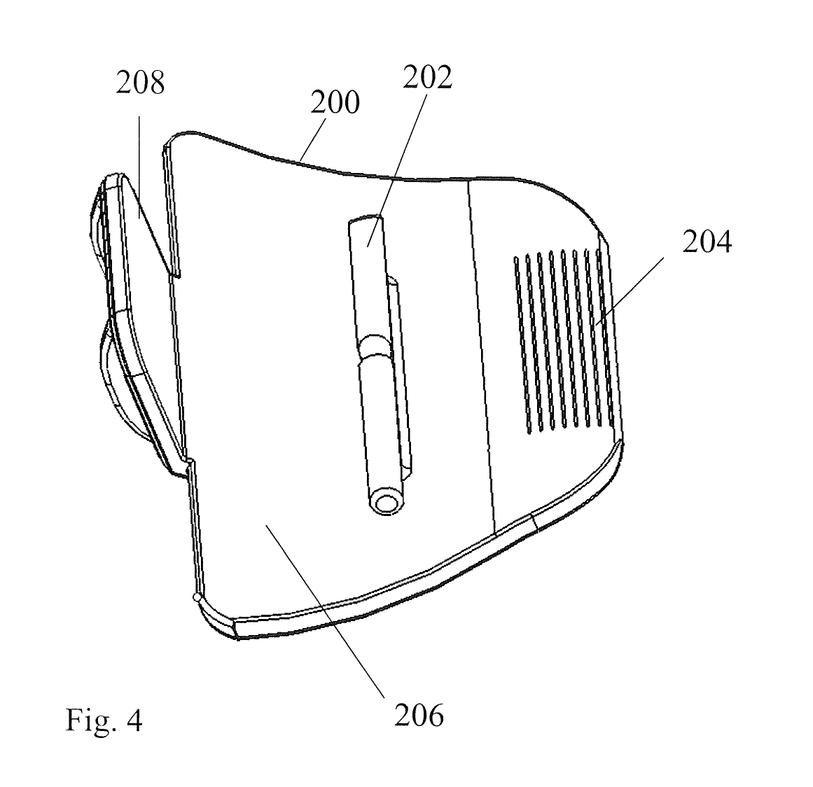

FIG. 4 is a perspective view of handle 200. This component may be made of aluminum or other suitable metal or be made of a suitable plastic. Handle 200 includes pivot pin 202, lift portion 204, bearing surface 206 and tab portion 208.

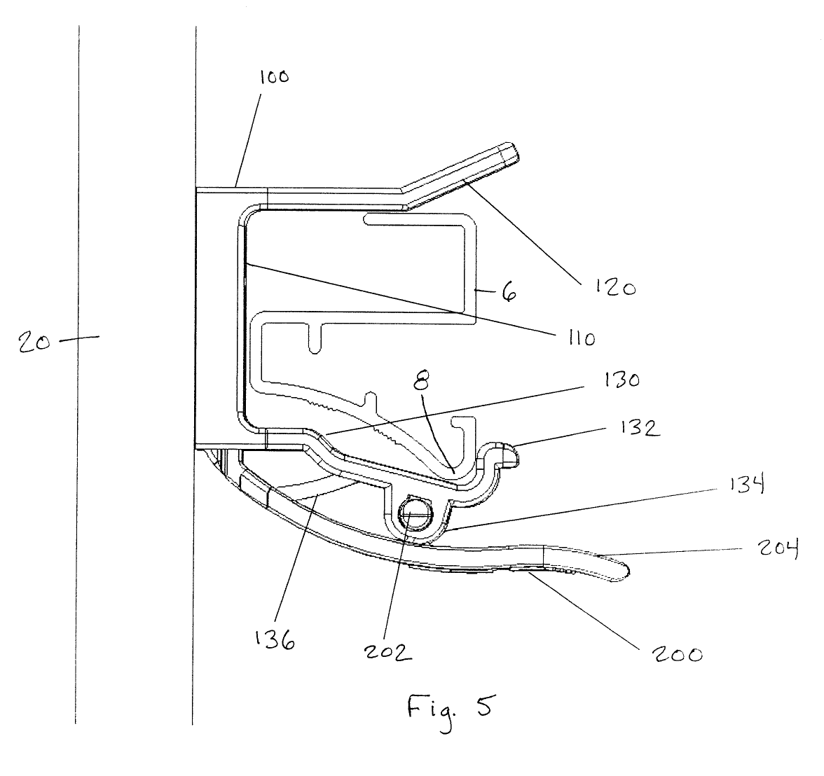

Referring now to FIG. 5, an assembled latch assembly 10 comprising latch base 100 and handle 200 is shown. To assemble the components, one side of pivot pin 202 is inserted into the corresponding pivot bearing 134 and the handle is slid to the side of the latch base as far as it will go. At this point, the other end of pivot pin 202 can be inserted into the other pivot bearing and the handle can then be centered on the latch base. The handle remains centered on the latch base as a result of the tab portion 208 being disposed within aperture 112.

FIG. 5 shows latch assembly 10 in a “relaxed” or “closed” condition. Wall portions 120 and 130 are angled outwardly to receive the stile of a sliding door. When the door is pushed toward the channel bottom portion 110, wall portions 120 and 130 spring outward until the protruding portion 8 of the door stile 6 is captured by catch portion 132 with the door stile 6 resting proximate to the doorjamb as shown in FIG. 2. Spring member 136 rests against the bearing portion 206 of handle 200, but remains in a relaxed condition in the configuration shown in FIG. 5.

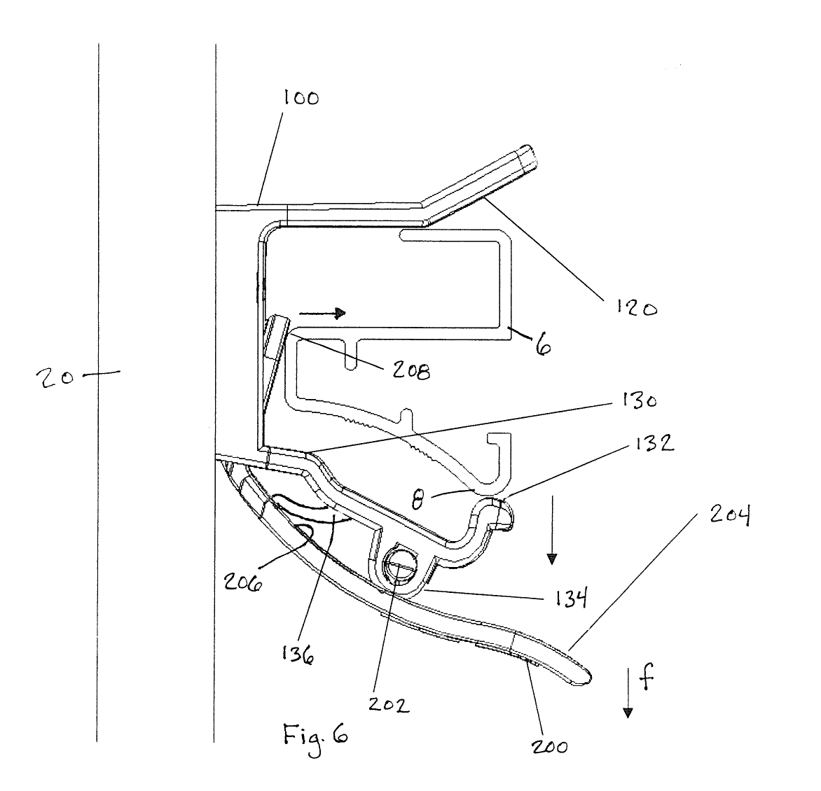

Referring now to FIG. 6, latch assembly 10 is shown in a “flexed” or “open” condition as a result of applying a lifting force f to the lift portion 204 of handle 200. This causes the handle to initially rotate about pivot pin 202 causing the bearing surface 206 to deflect spring member 136. Continued application of the lifting force draws wall portion 130 outward, releasing the door stile from catch portion 132. At the same time, tab portion 208 rotates and contacts door stile 6 to urge the door stile away from the channel bottom portion 110 so that when lifting pressure on the handle is released, the door stile is free of catch portion 132. Thus, the catch is released and the door is pushed to an unsecured position by a single operation using one hand.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

1. A latch assembly for a sliding door comprising:
a latch base comprising a single piece having a generally channel-shaped configuration for receiving a stile of a sliding door, the latch base comprising a channel bottom portion and first and second channel wall portions, the first channel wall portion having a catch portion, a pivot bearing portion and a protruding spring member;
a handle separate from and pivotally coupled to the latch base at the pivot bearing portion, the handle having a lift portion and a bearing surface, the bearing surface disposed for operative engagement with the spring member of the latch base, whereby, when the lift portion is pulled outwardly away from the latch base, the bearing surface bears against the spring member and the catch portion is pulled outwardly in the direction of the lift portion.

2. The latch assembly of claim 1, wherein the handle further comprises a tab portion disposed within an aperture in the channel bottom portion of the latch base, whereby, when the lift portion is pulled outwardly away from the latch base, the tab portion rotates into a channel defined by the channel bottom portion and the first and second channel wall portions.

3. The latch assembly of claim 1 wherein the handle further comprises a pivot pin operatively engaging the pivot bearing portion of the latch base.

4. A latch assembly for a sliding door comprising:
a latch base comprising a single piece configured generally as a channel defined by a channel bottom portion and first and second channel wall portions, the first channel wall portion having a catch portion;
a handle separate from and pivotally coupled to the latch base, the handle having a tab portion, the handle operatively engaging the latch base such that, when the handle is operated to pivot with respect to the latch base, the catch portion is pulled in an outwardly direction from the channel and the tab portion rotates into the channel.

5. The latch assembly of claim 4 wherein the latch base and handle are configured such that, when the handle is operated to pivot with respect to the latch base, outward pulling of the catch portion and rotation of the tab portion are substantially simultaneous.

6. A sliding door assembly comprising:
at least one sliding door having an edge portion;
a latch base secured to a doorjamb, the latch base having a generally channel-shaped configuration for receiving the edge portion of the sliding door, the latch base having a catch portion configured to retain the edge portion in a closed position proximate to the doorjamb;
a handle pivotally coupled to the latch base, the handle having a tab portion, the handle operatively engaging the latch base such that, when the handle is operated to pivot with respect to the latch base, the edge portion of the sliding door is released from the catch portion and the tab portion bears against the edge portion of the sliding door to urge the sliding door away from the doorjamb.

7. The sliding door assembly of claim 6 wherein the latch base and handle are configured such that, when the handle is operated to pivot with respect to the latch base, the edge portion of the sliding door is released from the catch portion and the tab portion urges the sliding door away from the doorjamb substantially simultaneously.

8. The sliding door assembly of claim 6 wherein the edge portion of the sliding door comprises a door stile.

9. The sliding door assembly of claim 8 wherein the door stile includes a lip portion and wherein the catch portion of the latch base is configured to operatively engage the lip portion of the door stile.
